(19) United States
(12) Patent Application Publication
(10) Pub. No.: US 2005/0110172 A1
(43) Pub. Date: May 26, 2005

(54) Humidifier

(75) Inventors: Shiro Tanaka, Yokosuka-shi (JP); Tamio Inamura, Fujisawa-shi (JP)

Correspondence Address: FOLEY AND LARDNER;SUITE 500, 3000 K STREET NW, WASHINGTON, DC, 20007, US

(73) Assignees: NISSAN MOTOR CO., LTD.; NOK CORPORATION

(21) Appl. No.: 10/990,442

(22) Filed: Nov. 18, 2004

(30) Foreign Application Priority Data
Nov. 26, 2003 (JP) 2003-395912

(51) Int. Cl. B01F 3/04

(52) U.S. Cl. 261/104

(57) ABSTRACT

A humidifier has a hollow-fiber membrane module comprising a cylindrical gas vent pipe, a permeable hollow-fiber membrane accommodated in the vent pipe, and a first distributing mechanism disposed in the vent pipe. The first distributing mechanism includes a plurality of vent holes formed along an outer periphery of the vent pipe, a distributor covering the vent holes, a gas conduit communicating with the distributor, and a connection hole connecting the gas conduit and the vent holes to each other. Widths of the vent holes in a circumferential direction of the vent pipe are equal to each other, and quantities of flow of gas flowing from the vent holes are equal to each other.

### BACKGROUND OF THE INVENTION

1. Technical field

The present invention relates to a humidifier provided in an air supply line supplying air to a fuel cell.

2. Related art

A fuel cell uses hydrogen gas as a fuel and allows hydrogen gas and oxygen gas to react with each other to generate electricity. The fuel cell receives attention in view of global environmental protection because exhaust gas is not generated for generating electricity. In recent years, attempts have been made to put the fuel cell to practical use as a power source of an automobile.

A vehicle such as an automobile mounts a fuel cell system including the fuel cell. An air supply line supplying air including oxygen gas is connected to the fuel cell, and a humidifier is disposed on the air supply line. The humidifier collects moisture contained in off-gas discharged from the fuel cell, air is humidified using the collected moisture, and the humidified air is supplied to the fuel cell.

Japanese Patent Application Laid-open No. 2002-66265 and Japanese Patent Application Laid-open No. 2003-265933 disclose conventional humidifiers. In the conventional humidifier, a plurality of hollow-fiber membrane modules is disposed. Each hollow-fiber membrane module has a vent pipe and a hollow-fiber membrane is accommodated in the vent pipe. A plurality of circular vent holes for introducing air humidified and a plurality of circular vent holes for discharging humidified air are formed along an outer periphery of theventpipe. The plurality of air-introducing vent holes are formed in one end of the vent pipe straightly along the circumferential direction of the vent pipe. The plurality of humidified air vent holes are formed in the one end of the vent pipe along the circumferential direction of the vent pipe on the same circumference. A distributor is formed on an outer periphery of each vent formed straightly along the circumferential direction of the vent pipe, and a gas conduit is connected to the distributor. An area of an opening of the vent hole closest to the gas conduit is the smallest, and a vent hole which is further from the gas conduit has greater opening area. By changing the area of the opening of the vent hole in accordance with distance from the gas conduit in this manner, gas can be introduced to the outside of the hollow-fiber membrane which is far from the gas conduit.

### SUMMARY OF THE INVENTION

In the conventional humidifier, the pitches between the vent holes are equal to each other, distances between the vent holes is different. When the distances between the vent holes are different, a compression force and a tensile stress applied in the axial direction of the vent pipe are varied, there is an adverse possibility that the vent pipe is buckled or deformed between the vent holes. When the vent pipe is buckled or deformed between the vent holes, gas is leaked or gas is unevenly distributed, the hollow-fiber membrane is damaged, the humidifying performance of the humidifier is largely deteriorated, and the lifetime of the humidifier is shortened.

In the conventional humidifier, when the opening area of each the vent hole formed in the vent pipe is to be changed, the width of the vent hole in the circumferential direction of the vent pipe and the length of the vent hole in the axial direction are changed, and there exists no uniformity. It is difficult to form vent holes having various opening areas in the vent pipe, and the producing method of the vent pipe is complicated in a designing point of view.

The present invention has been achieved in order to solve the above problems. That is, a humidifier of the invention has a hollow-fiber membrane module comprising a cylindrical gas vent pipe, a permeable hollow-fiber membrane accommodated in the vent pipe, and a first distributing mechanism disposed in the vent pipe. The first distributing mechanism includes a plurality of vent holes formed along an outer periphery of the vent pipe, a distributor covering the vent holes, a gas conduit communicating with the distributor, and a connection hole connecting the gas conduit and the vent holes to each other. Widths of the vent holes in a circumferential direction of the vent pipe are equal to each other, and quantities of flow of gas flowing from the vent holes equal to each other.

### BRIEF DESCRIPTION OF THE ACCOMPANYING DRAWINGS

FIG. 1 is a block diagram for explaining a first embodiment of the present invention and for showing a portion of a fuel cell system mounted in a fuel cell automobile;

FIG. 2 is a perspective view showing a structure of a hollow-fiber membrane module in a humidifier shown in FIG. 1;

FIG. 3 is a block diagram showing the hollow-fiber membrane module shown in FIG. 2;

FIG. 4 is a development view of the hollow-fiber membrane module shown in FIG. 2;

FIG. 5 shows a flow of air in the hollow-fiber membrane module; and

FIG. 6 is a block diagram for explaining a second embodiment of the invention and for showing an improved hollow-fiber membrane module.

### DETAILED DESCRIPTION OF THE PREFERRED EMBODIMENTS

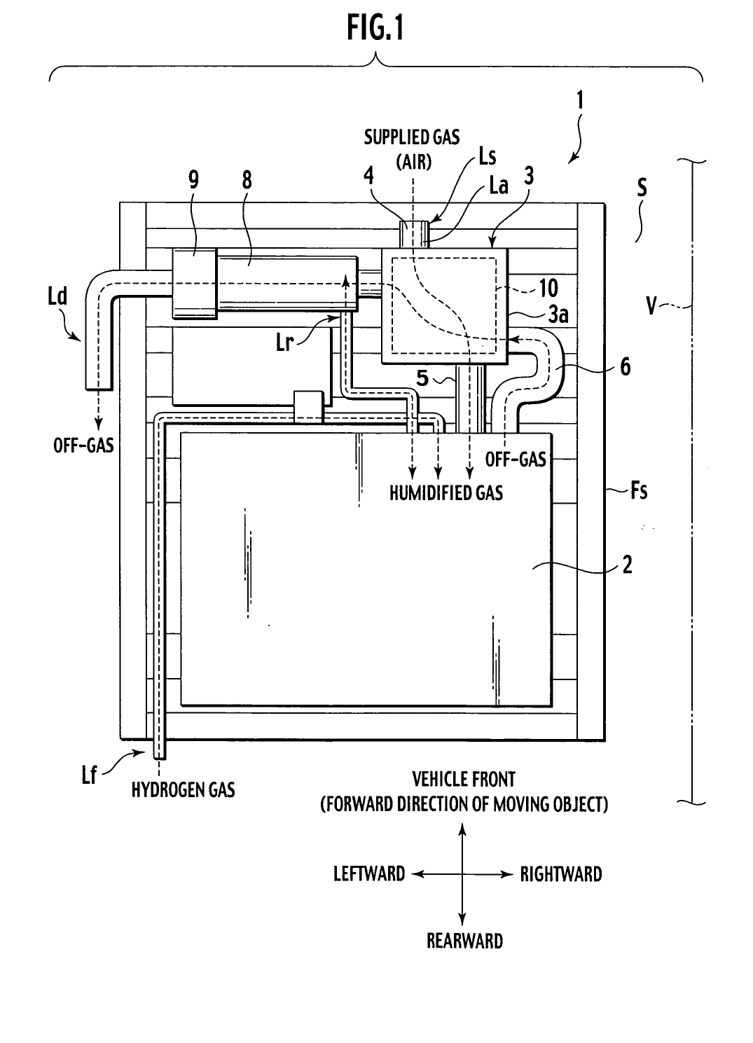

Humidifiers of embodiments of the present invention will be explained with reference to FIGS. 1 to FIG. 6.

### First Embodiment

In the first embodiment, a humidifier disposed in a fuel cell system mounted in a fuel cell vehicle will be explained based on FIGS. 1 to 5.

FIG. 1 is a block diagram showing a portion of the fuel cell system disposed below a floor of a fuel cell automobile.

As shown in FIG. 1, a fuel cell system 1 includes a fuel cell 2, a utility supply system (Ls), support frames (Fs), and an off-gas processing system.

The utility supply system (Ls) includes a fuel supply system and an oxidizer supply system. The fuel supply system includes a fuel supply line (Lf) supplying fuel to the fuel cell 2. The oxidizer supply system includes an oxidizer supply line (La) supplying oxidizer gas (air) to the fuel cell 2.

A humidifier 3 is disposed in the oxidizer supply line La of the fuel cell system 1. The humidifier 3 is connected to a gas inlet pipe 4 connected to a compressor (not shown) and to a gas outlet pipe 5 connected to the fuel cell 2.

The off-gas processing system includes an off-gas exhaust line (Ld) and an off-gas return line (Lr). The off-gas exhaust line (Ld) includes an off-gas inlet pipe 6 connecting the fuel cell 2 and the humidifier 3 to each other, and an off-gas outlet pipe 7 connected to the humidifier 3. A combustor 8 and a heat exchanger 9 are disposed in the off-gas outlet pipe 7.

As shown in FIG. 1, the fuel cell 2, the fuel supply line (Lf) and the oxidizer supply line (Ls) are supported on the support frame (Fs), and are mounted in an under-floor space (S) of the fuel cell automobile (V), and the fuel cell 2 is used as a driving source of the fuel cell automobile (V).

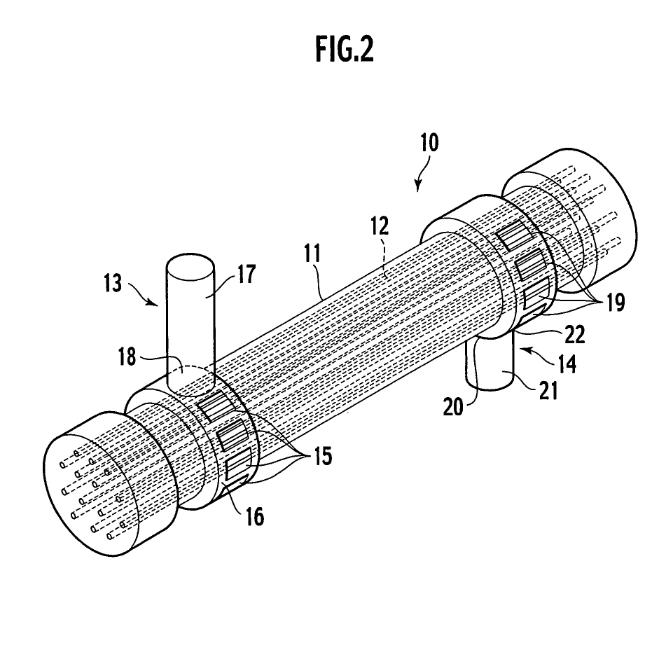

In a body 3a of the humidifier 3, two hollow-fiber membrane modules 10 are vertically superposed on each other and connected side-by-side and accommodated in the body 3a. FIG. 2 is a perspective view showing a structure of the hollow-fiber membrane module 10. As shown in FIG. 2, the hollow-fiber membrane module 10 has a permeable hollow-fiber membrane 12 accommodated in a cylindrical vent pipe 11. A first distributing mechanism 13 and a second distributing mechanism 14 are disposed on opposite ends of the vent pipe 11.

The first distributing mechanism 13 includes a plurality of vent holes 15 formed along an outer periphery of the vent pipe 12, a distributor 16 formed around the outer peripheries of the vent holes 15 for covering the vent holes 15, a gas conduit 17 communicating with the distributor 16, and a connection hole 18 for connecting the gas conduit 17 and the vent holes to each other. An end of the gas conduit 17 is connected to the gas inlet pipe 4.

The second distributing mechanism 14 has the same structure as that of the first distributing mechanism 13, and includes a plurality of vent holes 19 formed along the outer periphery of the vent pipe 12, a distributor 20 formed around the outer peripheries of the vent holes 19 for covering the vent holes 19, a gas conduit 21 communicating with the distributor 20, and a connection hole 22 connecting the gas conduit 21 and the vent holes 19 with each other. An end of the gas conduit 21 is connected to the gas outlet pipe 5. As shown in FIG. 2, the second distributing mechanism 14 is disposed in a direction with respect to an axial direction of the vent pipe 11, the connection hole 18 of the first distributing mechanism 13 and the connection hole 22 of the second distributing mechanism 14 are opposed to each other.

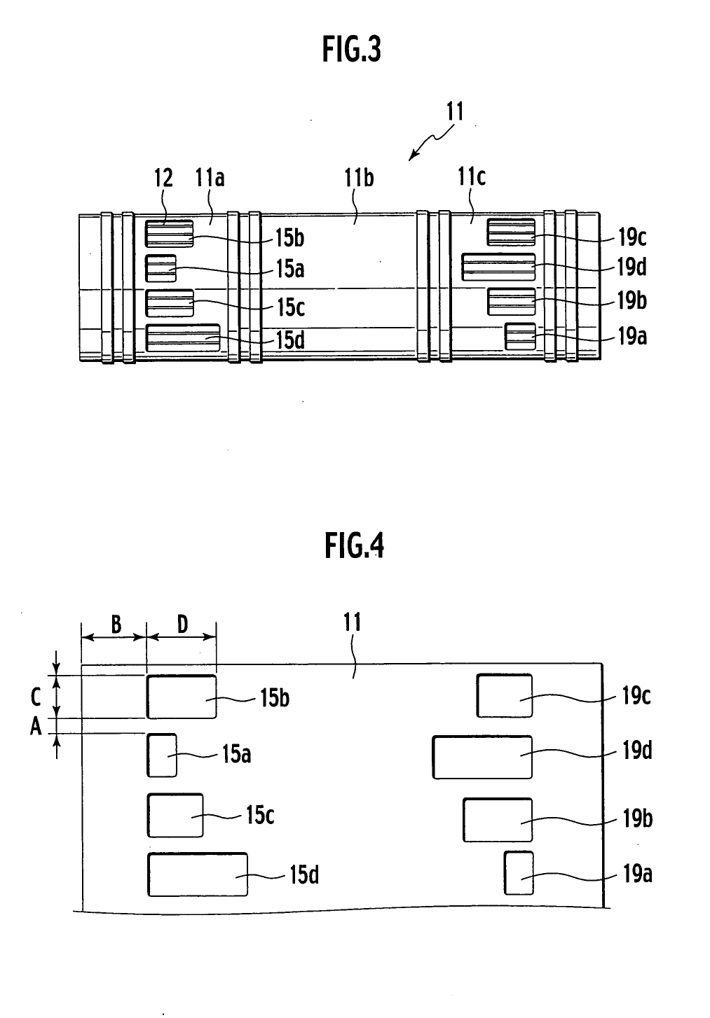

FIG. 3 is a side view of the vent pipe 11 shown in FIG. 2, and FIG. 4 is a development view of the vent pipe 11. As shown in FIG. 3, the vent pipe 11 comprises a front section 11a, a central section 11b and a rear section 11c. The plurality of vent holes 15 is formed in the front section 11a of the vent pipe 11 along the outer periphery of the front section 11a. The vent hole 15a having the smallest opening area is disposed directly below the gas conduit 17. Opening areas of vent holes 15b, 15c and 15d are gradually increased as distances of the vent holes from the gas conduit 17 are longer along the circumferential direction of the vent pipe 11a from the vent hole 15a. Like the front section 11a, the rear section 11c of the vent pipe 11 is formed with the plurality of vent holes 19 along the outer periphery of the vent pipe 11. The vent hole 19a having the smallest opening area is disposed directly below the gas conduit 21. Opening areas of vent holes 19b, 19c and 19d are gradually increased as distances of the vent holes from the gas conduit 21 are longer along the circumferential direction of the vent pipe 11a from the vent hole 19a.

As shown in FIG. 4, distances A between adjacent vent holes 15a to 15d are equal to each other, and the vent holes 15a, 15b, 15c and 15d are formed at constant distances B from the end of the vent pipe 11 in the axial direction. The opening areas of the vent holes 15 are adjusted such that widths C between the vent holes 15a, 15b, 15c and 15d in the circumferential direction are equal to each other, and lengths D of the vent pies is different from each other in the axial direction of the vent pipe 11. By designing the vent holes 15a, 15b, 15c and 15d such that their opening areas are different from each other, the difference of flow path resistances to the vent holes are compensated, and quantities of flow of gas flowing from the vent holes 15 are equal to each other.

As shown in FIG. 1, off-gas discharged from the fuel cell 2 is introduced into the hollow-fiber membrane module 10 in the humidifier 3 through the off-gas inlet pipe 6. The introduced off-gas contains moisture. As shown in FIG. 3, the off-gas is introduced from the end of the vent pipe 11 closer to the rear section 11c into the hollow-fiber membrane 12, and flows toward the front section 11a from the central section 11b of the vent pipe 11 and flows into the hollow-fiber membrane 12. When the off-gas flows into the hollow-fiber membrane 12, capillary condensation phenomenon is generated by capillary, and moisture contained in the off-gas passes through the capillary and moves outside of the hollow-fiber membrane 12. The off-gas flowed into the hollow-fiber membrane 12 on the side of the rear section 11c of the vent pipe 11 is introduced into the combustor 8 through the off-gas outlet pipe 7 shown in FIG. 1.

On the other hand, air is introduced into the humidifier 3 from the compressor (not shown) through the gas inlet pipe 4 and the gas conduit 17 in the humidifier 3. The introduced air flows into the distributor 16 from the gas conduit 17 in the first distributing mechanism 13 of the hollow-fiber membrane module 10. As shown in FIG. 5, the air flowed into the distributor 16 flows in the directions of arrows S1, S2 and S3. The air flowing in the direction of the arrow S1 flows to the vent holes 15a, 15c, 15d and 15e, and the air flowing in the direction of the arrow S2 flows to the vent holes 15d and 15e. The air flowing in the direction of the arrow S3 flows into the vent hole 15e. As the distance from the gas conduit 17 is longer, the amount of air to be introduced into unit area of the vent hole 15 is reduced, but since the area of the vent hole 15 is increased, the amount of air to be introduced into the entire area of the vent holes 15 is uniform. The air introduced into each vent hole 15 flows outside of the hollow-fiber membrane 12 and flows into the rear section 11c through the central section 11b of the vent pipe. Moisture moved from inside to outside of the hollow-fiber membrane 12 is contained in air flowing outside of the hollow-fiber membrane 12 and the air is humidified. The humidified air flows from the vent hole 19e of the second distributing mechanism 14 in the directions of arrows T1, T2 and T3 as shown in FIG. 5. The humidified air from the vent hole 19d which is adjacent to the vent hole 19e flows in the directions of the arrows T2 and T3, and the humidified air from the vent hole 19a and the vent hole 19b which is adjacent to the vent hole 19d flows in the direction of the arrow T3. The humidified air from the vent holes 19e, 19d, 19b and 19a flows into the gas conduit 21 through the distributor 20. The distances from the gas conduit 21 to the vent holes 19e, 19d, 19b and 19a are different from each other, but the amount of humidified air flowing out from the vent holes 19 is equal to each other. The humidified air flowing out from the gas conduit 21 is supplied to the fuel cell 2 through the gas outlet pipe 5.

According to the humidifier 3 of this embodiment, air which is to be humidified is allowed to flow outside of the hollow-fiber membrane 12, and the off-gas is allowed to flow inside the hollow-fiber membrane 12. Alternatively, the air and gas may flow inside and outside of the hollow-fiber membrane 12 respectively, and the same effect can be obtained.

According to this embodiment, by changing the opening areas of the vent holes in accordance with the distances from the gas conduit, air can flow over the entire outside space of the hollow-fiber membrane, and moisture collected from the off-gas can be dispersed over the air. As a result, the humidifying performance of the hollow-fiber membrane module is enhanced.

According to this embodiment, the compression force and tensile force are applied in the axial direction of the vent pipe. Since the widths of the vent holes in the circumferential direction of the vent pipe are equal to each other and the lengths of the vent holes in the axial direction of the vent pipe are changed and the opening areas of the vent holes are changed, stress applied to the vent pipe between the vent hole and the end of the vent pipe is constant. Buckling or deformation between the vent holes is suppressed, and leakage of gas and deterioration of gas distribution can be reduced. Although the compression force is applied in the axial direction of the vent pipe, since the distances between the adjacent vent holes are set constant and the widths between the vent holes are equal to each other, the hollow-fiber membrane or the vent pipe can be prevented from being damaged. As a result, the lifetime of the hollow-fiber membrane module can be increased. Since the opening areas of the vent holes can be changed only by changing the lengths of the vent holes in the axial direction of the vent pipe, it is easy to design the vent pipe.

### Second Embodiment

In the second embodiment, the humidifier 1 of the first embodiment is improved in order to prevent the fiber of the hollow-fiber membrane from being cut. This humidifier will be explained.

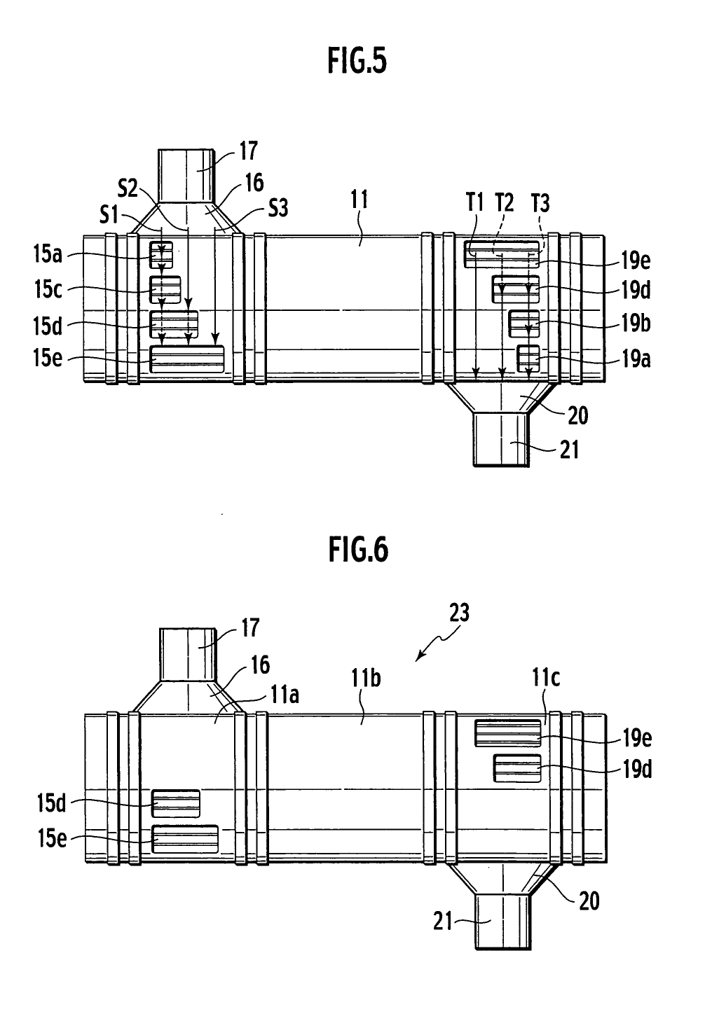

FIG. 6 is a side view showing a structure of a hollow-fiber membrane module in the humidifier of the second embodiment. Substantially the same elements as those shown in FIG. 5 of the first embodiment are designated with like reference numerals, and explanation thereof is omitted. As shown in FIG. 6, in the hollow-fiber membrane module 23 of the second embodiment, no vent hole is formed directly below and around the gas conduit 17. Vent holes 15d and 15e are formed only at positions away from the gas conduit 17. No vent hole is formed directly below and around the gas conduit 21. Vent holes 19d and 19e are formed only at positions away from the gas conduit 21.

According to the hollow-fiber membrane module 23, the distances from the gas conduit 17 and the vent holes 15d and 15e are long, the flow velocity of air introduced from the gas conduit 17 is reduced and then, air flows outside the hollow-fiber membrane 12 from the vent holes 15d and 15e. Air flowing outside of the hollow-fiber membrane 12 is humidified, and the humidified air is then introduced into the fuel cell 2 through the vent holes 19d and 19e while keeping the low velocity without being affected by the gas conduit 21.

According to this embodiment, vent holes are formed only at positions far from the gas conduit, air with low velocity can be introduced into the hollow-fiber membrane. High velocity air does not come into contact with the hollow-fiber membrane, and the fiber of the hollow-fiber membrane is prevented from being cut and damaged.

In this embodiment also, like the first embodiment, since the opening areas of the vent holes are changed, air is uniformly introduced outside of the hollow-fiber membrane, and the humidifying performance of the humidifier can be enhanced.

The contents of Japanese Patent Application No. 2003-395912, filed Nov. 26, 2003, are hereby incorporated by reference.

Although the invention has been described above by reference to certain embodiments of the invention, the invention is not limited to the embodiments described above will occur to those skilled in the art, in light of the teachings. The scope of the invention is defined with reference to the following claims.

1. A humidifier having a hollow-fiber membrane module comprising:
a cylindrical gas vent pipe;
a permeable hollow-fiber membrane accommodated in the vent pipe; and
a first distributing mechanism disposed in the vent pipe,
wherein said first distributing mechanism includes a plurality of vent holes formed along an outer periphery of the vent pipe; a distributor covering the vent holes; a gas conduit communicating with the distributor; and a connection hole connecting the gas conduit and the vent holes to each other, and
widths of the vent holes in a circumferential direction of the vent pipe are equal to each other, and quantities of flow of gas flowing from the vent holes are equal to each other.

2. The humidifier as claimed 1, wherein said connection hole of the first distributing mechanism is connected to a gas outlet pipe.

3. The humidifier as claimed 1, wherein said connection hole of the first distributing mechanism is connected to a gas inlet pipe.

4. The humidifier as claimed 1, further comprising a second distributing mechanism having the same structure as that of said first distributing mechanism,
wherein said connection hole of the first distributing mechanism and a connection hole of the second distributing mechanism are disposed on opposite sides with respect to an axial direction of the vent pipe.

5. The humidifier as claimed 1, wherein widths of the vent holes are equal to each other in the circumferential direction of the vent pipe, and lengths of the vent holes in the axial direction of the vent pipe are different from each other.

6. The humidifier as claimed 1, wherein said vent holes are formed on the same circumference at constant distances from one another from opposite ends of the vent pipe in the axial direction thereof.
